(19) United States
(12) Patent Application Publication
(10) Pub. No.: US 2002/0162792 A1
(43) Pub. Date: Nov. 7, 2002

(54) Polymer membrane meshes

(76) Inventor: Robert F. Zepf, Solana Beach, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 09/846,777

(22) Filed: May 1, 2001

(51) Int. Cl. B01D 63/00; B01D 71/00

(52) U.S. Cl. 210/500.21; 264/41

(57) ABSTRACT

The present invention relates to polymer membrane meshes having pores with an average diameter from about 10 μm to about 200 μm. The membrane meshes are cast from polymer dope mixes that are either homogeneous solutions or stable colloidal dispersions.

### FIELD OF THE INVENTION

The present invention relates to polymer membrane meshes having pores with an average diameter from about 10 μm to about 200 μm. The membrane meshes are cast from polymer dope mixes that are either homogeneous solutions or stable colloidal dispersions.

### BACKGROUND OF THE INVENTION

Many types of filtration media are available for filtering gases and liquids. One type of such filtration medium is the polymeric membrane. Most polymeric membranes are generally made by first preparing a casting solution or dispersion made up of the chosen polymer in a suitable solvent. The casting dope is then formed into a thin sheet and the polymer is precipitated into a solid phase. Precipitating the polymer into a solid membrane is normally carried out by evaporating the solvent or contacting the polymer with a non-solvent liquid in a quench bath. In many cases, the casting solution also includes a specific concentration of a non-solvent which can affect the porosity of the membrane.

Some filtration membranes have a layer of relatively small pores on one side (termed herein a “skin”) when compared to the other side, while other membranes do not contain this type of layer (termed herein “skinless”). A skinned membrane is typically created by quenching a polymeric casting solution of sufficient polymer concentration in a strong non-solvent. The resultant membrane has considerably smaller pores on the “skin” face than on the opposite face.

The casting conditions not only affect whether a skin is produced, but they can also determine the asymmetry of pores within the membrane. For example, a perfectly symmetrical or isotropic membrane has pores of the same diameter on both faces and throughout the support structure between the faces. However, a highly asymmetric membrane may have pores that change in diameter by 5:1, 10:1, 10,000:1 or more from one face to the other. Both isotropic and asymmetric membranes typically have average pore sizes ranging up to a maximum of about 10 μm, or more.

### SUMMARY OF THE INVENTION

Embodiments of the present invention provide a polymer membrane mesh and a method for preparing the mesh. In a first embodiment, the polymer membrane mesh includes a first surface having first surface pores, a second surface having second surface pores, and a support structure between the first surface and the second surface, the support structure having a reticulate network of flow channels connecting the pores of the first surface with the pores of the second surface, wherein both or either of the first surface pores and the second surface pores have an average pore diameter of greater than or equal to about 10 μm, preferably greater than about 20 μm, more preferably about 10 μm to about 200 μm, even more preferably about 20 μm to about 150 μm, or most preferably about 30 μm to about 100 μm. The membrane may possess a bubble point of less than about 0.69 kPa (1 psi), or a water flow rate of greater than about 30,000 ml/min for a 90 mm diameter disc of the membrane at a pressure of 6.9 kPa (10 psi). The membrane may have a thickness greater than about 50 μm, more preferably from about 50 μm to about 500 μm, even more preferably from about 75 μm to about 200 μm, or most preferably from about 90 μm to about 150 μm.

In a further aspect of the embodiment, the membrane may include a sulfone polymer, including polyethersulfone, polyarylsulfone, polysulfone, and mixtures thereof. The membrane may include one or more polymers including polyvinylidene fluoride, acrylic copolymer, polyolefins including polyethylene or polypropylene, polyester, polytetrafluoroethylene, polyurethane, polycarbonate, poly(tetrafluoroethylene-co-ethylene), polyamide, polystyrene, and mixtures thereof.

In yet another aspect of the embodiment, the membrane further includes a hydrophilic component. The hydrophilic component may include polyvinylpyrrolidone, polyethylene glycol, polyvinylacetate, and mixtures thereof. The weight ratio of polymer to hydrophilic component in the membrane may range from about 1:20 to about 20:1, more preferably from about 1:10 to about 10:1.

In a second embodiment of the present invention, a method for preparing a polymer membrane mesh is provided. The method includes providing a casting dope including a polymer, a nonsolvent, and a solvent; casting the dope to form a thin film; exposing the film to a humid atmosphere for a period of time sufficient to allow formation of surface pores greater than about 10 μm in diameter; coagulating the film in a coagulation bath; and recovering from the coagulation bath a polymer membrane mesh, the membrane mesh including a first surface having first surface pores, a second surface having second surface pores, and a support structure between the first surface and the second surface, the support structure having a reticular network of flow channels connecting the pores of the first surface with the pores of the second surface, wherein both or either of the first surface pores and the second surface pores have an average pore diameter greater than about 10 μm.

In another aspect of the embodiment, the method further includes rinsing the mesh in a rinsing bath, wherein said rinsing step is conducted after said coagulating step. The method may also further include drying the mesh at an elevated temperature.

In a further aspect of the embodiment, the period of time ranges from about 20 seconds to about 2 minutes, preferably from about 20 seconds to about 70 seconds, more preferably from about 30 seconds to about 60 seconds, or most preferably from about 35 seconds to about 55 seconds.

In a further aspect of the embodiment, the humid atmosphere has a humidity ranging from about 30% relative humidity to about 100% relative humidity, preferably from about 40% relative humidity to about 100% relative humidity, more preferably from about 40% relative humidity to about 70% relative humidity, even more preferably from about 50% relative humidity to about 69% relative humidity, or most preferably about 55% relative humidity.

In other aspects of the embodiment, the dope includes a homogeneous solution or a dispersion.

In further aspects of the embodiment, the nonsolvent may include alcohols, alkanes, ketones, carboxylic acids, ethers, esters, and mixtures thereof, and preferably includes 2-methoxyethanol, propionic acid, t-amyl alcohol, methanol, ethanol, isopropanol, hexanol, heptanol, octanol, acetone, butyl ether, methylethylketone, methylisobutylketone, ethyl acetate, amyl acetate, glycerol, diethyleneglycol, di(ethyleneglycol)diethylether, di(ethyleneglycol)dibutylether, polyethylene glycol, propionic acid, hexane, propane, nitropropane, heptane, octane, and mixtures thereof. The nonsolvent may also include water, or a mixture of polyethylene glycol and water. The dope may include from about 12 wt. % to about 32 wt. % of nonsolvent, preferably from about 15 wt. % to about 29 wt. % of nonsolvent, more preferably from about 18 wt. % to about 26 wt. % of nonsolvent, or most preferably from about 20 wt. % to about 24 wt. % of nonsolvent.

In further aspects of the embodiment, the solvent may include dimethylformamide, dimethylacetamide, dioxane, dimethylsulfoxide, chloroform, tetramethylurea, tetrachloroethane, and mixtures thereof. Preferably, the solvent includes N-methylpyrrolidone. The dope may include from about 50 wt. % to about 80 wt. % of solvent, preferably from about 55 wt. % to about 75 wt. % of solvent, more preferably from about 60 wt. % to about 70 wt. % of solvent, even more preferably 64 wt. % to about 66 wt. % of solvent, even more preferably from about 2 wt. % to about 20 wt. % of polymer, more preferably from about 4 wt. % to about 15 wt. % of polymer, or most preferably from about 5 wt. % to about 10 wt. % of polymer.

In another aspect of the embodiment, the polymer includes polysulfone. The dope may include about 9 wt. % of polysulfone.

In yet another aspect of the embodiment, the dope may further include a hydrophilic component. The dope may include from about 1 wt. % to about 10 wt. % of hydrophilic component, preferably from about 2 wt. % to about 6 wt. % of hydrophilic component, more preferably from about 3 wt. % to about 5 wt. % of hydrophilic component, or most preferably from about 4 wt. % to about 5 wt. % of hydrophilic component. The weight ratio of polymer to hydrophilic component may range from about 1:5 to about 20:1, preferably from about 1:2 to about 1:4.

In yet another aspect of the embodiment, the coagulation bath includes water. The coagulation bath may be at a temperature ranging from about 2° C. (36° F.) to about 85° C. (185° F.), preferably from about 24° C. (75° F.) to about 63° C. (145° F.), more preferably from about 32° C. (90° F.) to about 54° C. (129° F.), most preferably from about 38° C. (100° F.) to about 48° C. (118° F.). The rinse bath may include water.

### BRIEF DESCRIPTION OF THE DRAWINGS

FIG. 1, including FIGS. 1a and 1b, is a scanning electron microscope micrograph of a polymer membrane mesh having a surface pore size of about 50 μm.

FIG. 1a shows one surface of the membrane.

FIG. 1b shows the membrane in cross-section.

FIG. 2, including FIGS. 2a and 2b, is a scanning electron microscope micrograph of a polymer membrane mesh having a surface pore size of about 100 μm.

FIG. 2a shows one surface of the membrane.

FIG. 2b shows the membrane in cross-section.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

While conventional membranes having 10 μm or smaller maximum pore size are useful in a variety of applications, such membranes are rendered unsuitable for other applications due to the average pore size being too small. Non-limiting examples of applications where larger pore size membranes are useful include air filtration, coarse filtration, low pressure drop supports, and filtration of body fluids. The meshes are particularly well-suited as supports for other membranes, especially those with the same polymer constituents, and as carriers for surface active agents, charged groups, and ion exchange groups. For such applications, it may be desirable to provide a polymeric membrane having an average pore size substantially larger than that of conventional polymeric membranes, the pore size sufficiently large that the membrane functions as a mesh.

The Polymer

The membrane meshes of preferred embodiments may be prepared from any polymer capable of forming a membrane. In a particularly preferred embodiment, the polymer is a sulfone polymer such as polysulfone, polyethersulfone, or polyarylsulfone. A number of polysulfone-type polymers are available and can be used in preferred embodiments. One example of a suitable polysulfone is a polyarylsulfone P-3500 available from Amoco Polymers of Alpharetta, Ga. Other suitable polymers include polyvinylidene fluoride (PVDF), polyolefins including polyethylene and polypropylene, polycarbonates, polytetrafluoroethylene (PTFE), poly(tetrafluoroethylene-co-ethylene) (ECTFE), acrylic copolymers, polyamides, polyesters, polyurethanes, and polystyrenes. The polymer may be a homopolymer, copolymer, terpolymer, or more complex polymer. A single polymer or combination of two or more polymers may be used. The polymer may be subjected to a pretreatment such as, for example, sulfonation or grafting, prior to forming the casting dope. There is no particular molecular weight range limitation for useful polymers.

The Casting Dope

The polymer membrane meshes of the preferred embodiments are preferably prepared from stable, clear homogeneous solutions and/or stable colloidal dispersions. The solutions or dispersions can be prepared through the use of solvents alone, or in combination with non-solvents.

The meshes are generally prepared from a casting solution or dispersion of a polymer such as, for example, a polysulfone-type polymer, along with particular concentrations of polymer solvents and non-solvents. The concentration of the polymer in the casting solution is low enough to form a substantially all-reticulated structure, but high enough to produce a coherent mesh. If the polymer concentration is too low, the resulting membrane can have inadequate coherency and, in the extreme case, only dust is formed. If the polymer concentration is too high, the membrane structure is not substantially reticulated and can contain at least some granular structures.

Although the appropriate concentration of polymer varies somewhat depending upon the particular conditions used, (e.g., solvents, etc.), the polymer concentration is generally from about 2 wt. % to about 20 wt. %. Typically, the casting solution contains from about 4 wt. % to about 15 wt. % polymer, preferably the casting solution includes about 5 wt. % to about 10 wt. % polymer, and most preferably the polymer is polysulfone at about 7, 8, or 9 wt. %.

The meshes of the preferred embodiments may be rendered hydrophilic through co-casting a hydrophobic polymer such as, for example, a polysulfone-type polymer, with a hydrophilic component such as a hydrophilic polymer or a surfactant. In a preferred embodiment, the hydrophilic polymer is polyvinylpyrrolidone. Other suitable hydrophilic polymers include polyethylene glycol, polyvinylpyrrolidone, and polyvinylacetate. A suitable concentration of hydrophilic polymer can vary depending upon the particular composition of the dope mix and the casting and quenching conditions used. However, the hydrophilic polymer concentration is generally from about 1 wt. % to about 10 wt. %. Typically, the casting solution contains from about 2 wt. % to about 6 wt. % hydrophilic polymer, preferably the casting solution includes about 3 wt. % to about 5 wt. % hydrophilic polymer, more preferably the hydrophilic polymer is about 4 to 5 wt. % of the solution, and most preferably the hydrophilic polymer is polyvinylpyrrolidone and is about 4 to 5 wt. % of the solution.

It has been found that a stable, clear homogeneous casting solution or stable colloidal dispersion can be obtained by dissolving the polymer in a suitable solvent such as, for example, dissolving polysulfone in N-methylpyrrolidone. Examples of other suitable solvents include dipolar aprotic solvents such as dimethylformamide, dimethylacetamide, dioxane, N-methyl pyrrolidone, dimethylsulfoxide, chloroform, tetramethylurea, or tetrachloroethane, and their mixtures. The amount of solvent that may be employed to prepare a membrane mesh can be between about 50 wt. % and about 80 wt. %; desirably between about 55 wt. % and about 75 wt. %; more desirably between about 60 wt. % and about 70 wt. %, preferably between about 63 wt. % and about 67 wt. %, more preferably between about 64 wt. % and about 66 wt. %; and most preferably the solvent is N-methylpyrrolidone and is present at about 64, 65, or 66 wt. % of the solution. The precise amount of solvent to be used is determined by the particular casting solution, including the particular polymer, non-solvent and the other conditions of the method of preparation of the particular mesh of interest.

A non-solvent may be added to the casting solution. In a preferred embodiment, the non-solvent includes both polyethylene glycol and water, and is added after the polymer (i.e., a polysulfone) is dissolved in the solvent. Additional examples of appropriate non-solvents include alcohols, for example, methanol, ethanol, isopropanol, 2-methoxyethanol, amyl alcohols such as t-amyl alcohol, hexanols, heptanols, and octanols; alkanes such as hexane, propane, nitropropane, heptane, and octane; and ketones, carboxylic acids, ethers and esters such as acetone, propionic acid, butyl ether, ethyl acetate, and amyl acetate, di(ethyleneglycol) diethylether, di(ethyleneglycol) dibutylether, polyethylene glycol, methylethyl-ketone, methylisobutylketone, glycerol, diethyleneglycol, and their mixtures. The amount of non-solvent which may be employed to prepare a membrane mesh is between about 12 wt. % and about 32 wt. % of the casting solution; preferably between about 15 wt. % and about 29 wt. %; more preferably between about 18 wt. % and 26 wt. %; most preferably between about 20 wt. % and 24 wt. %, such as, for example, 21, 22, or 23 wt. % of the casting solution. In a preferred embodiment, polyethylene glycol makes up about 19 or 20 wt. % and water about 2 wt. % of the casting solution. However, selection of the precise amount of nonsolvent to be used is based on the particular casting solution, including particular polymer, solvent and the other conditions of the method of preparation of the particular mesh of interest.

The Casting Process

In general, the overall method of preparing a polymeric membrane mesh includes the steps of providing a casting dope comprising a solution or stable colloidal dispersion. The casting dope is then cast as a thin film and exposed to a gaseous environment. Once the casting dope has been exposed to the gaseous environment, it is coagulated in a quench bath. After coagulating, the resulting polymer membrane mesh may be rinsed in a suitable solvent, then air- or oven-dried.

The membrane meshes of preferred embodiments can be cast using any conventional procedure wherein the casting solution or dispersion is spread in a layer onto a nonporous support from which the membrane later can be separated after quenching. The membrane meshes can be cast manually by being poured, cast, or spread by hand onto a casting surface followed by application of a quench liquid onto the casting surface. Alternatively, the membrane meshes may be cast automatically by pouring or otherwise casting the solution onto a moving belt. The casting solution or dispersion may be any suitable temperature, i.e., room temperature or any temperature at which the casting dope is capable of being cast. Preferably, the temperature is between about 10° C. (50° F.) and about 38° C. (100° F.), more preferably between about 16° C. (61° F.) and about 32° C. (90° F.), and most preferably between 21° C. (70° F.) and 26° C. (79° F.). If the casting dope comprises a polysulfone in N-methylpyrrolidone solvent, the temperature is preferably about room temperature.

One type of moving belt support is polyethylene coated paper. In casting, particularly in automatic casting, mechanical spreaders can be used. Mechanical spreaders include spreading knives, a doctor blade or spray/pressurized systems. A preferred spreading device is an extrusion die or slot coater which has a chamber into which the casting formulation can be introduced. The casting solution is then forced out of the chamber under pressure through a narrow slot. Membrane meshes may also be cast by means of a doctor blade with a knife gap of typically about 380 μm (15 mils) through about 1270 μm (50 mils), preferably about 406 μm (16 mils) through about 635 μm (25 mils), and more preferably about 430 μm (17 mils). The relationship between the knife gap at casting and the final thickness of the membrane mesh is a function of the composition and temperature of the casting solution, the duration of exposure to the gaseous environment, such as humid air, the relative humidity of the air during exposure. In addition, the temperature of the quench bath and many other factors can affect the overall thickness of the final membrane. Membrane meshes typically shrink upon gelling, losing from about 20% to about 80% of their thickness.

Generally, to produce a membrane mesh, the cast film is exposed to a gaseous environment, such as air, sufficiently long to induce formation of relatively large surface pores. Another factor that is important to the manufacture of the meshes of the preferred embodiments is the exposure time and exposure conditions that exist between casting and quenching the casting solution. Preferably, the casting solution or dispersion is exposed to humid air after casting but before quenching. Ambient humidity is acceptable as are other humidity conditions. In a preferred embodiment, the gaseous environment has a relative humidity of between about 30% and about 80%, preferably between about 40% and about 70%, more preferably between about 50% and about 69%, and most preferably about 55%. In addition, the air is preferably circulated to enhance contact with the cast solution or dispersion. The gaseous atmosphere may be any suitable temperature, but is typically between about 21° C. (70° F.) and about 43° C. (109° F.), preferably between about 27° C. (81° F.) and about 38° C. (100° F.), and more preferably between about 29° C. (84° F.) and about 35° C. (95° F.). Most preferably, the temperature is from about room temperature to slightly higher than room temperature.

The membrane meshes of the preferred embodiments result from a relatively long exposure time to the gaseous environment after casting and before quenching. The exposure time to the gaseous environment is preferably between about 20 seconds and 70 seconds, 2 minutes, or more. More preferably, the exposure time is between about 30 seconds and 60 seconds, and most preferably between about 35 seconds and 55 seconds. Increasing the air exposure time, over this range, tends to increase permeability and pore size of the resulting membrane mesh.

Following casting and exposure to a gaseous environment, such as air, the cast dispersion or solution is quenched or coagulated. In a preferred embodiment, quenching is accomplished by transporting the cast membrane on a moving belt into the quenching liquid, such as a water bath. Most commonly, the quenching or coagulating liquid is water, however, any suitable liquid that is not a solvent for the resulting membrane mesh may be used. In the quench or coagulating bath, the polymer precipitates or coagulates to produce the desired porous reticulated structure.

The temperature of the quench bath can affect the porosity of the membrane. In general, warmer quench baths result in more porous membrane meshes. Generally, a wide temperature range can be utilized in the quenching step, ranging from about 2° C. (36° F.) to about 85° C. (185° F.), preferably from about 24° C. (75° F.) to about 63° C. (145° F.), and more preferably from about 32° C. (90° F.) to about 54° C. (129° F.). The lower temperature limit is determined by the freezing point of the particular quench liquid. Preferably, the quench liquid is water and the quenching temperature is between about 38° C. (100° F.) and about 48° C. (118° F.). The temperature of the quench bath may cause marked changes in the pore diameters of the membrane mesh. Where higher quench temperatures are utilized, the membrane meshes possess larger pores. Conversely, where lower temperatures are utilized, smaller pores form.

Membrane meshes are recovered from the quench bath in the conventional manner by physical removal. The resulting membrane meshs are typically washed free of solvent and may be dried to expel additional increments of solvent, diluent, and quench liquid. Washing liquids include any suitable liquid that is not a solvent for the resulting membrane mesh. In a preferred embodiment, the rinse liquid is deionized water. The membrane meshes may be dried by air drying or oven drying. In a preferred embodiment, the membrane is oven dried at elevated temperature. The temperature is selected such that exposure of the membrane mesh to that temperature does not substantially affect the performance characteristics of the membrane mesh, for example, by melting the polymer comprising the mesh. Preferably, drying temperatures ranging from about 120° C. (248° F.) to about 190° C. (374° F.), more preferably from about 135° C. (275° F.) to about 177° C. (351° F.), and most preferably from about 155° C. (311° F.) to about 171° C. (340° F.) are used. It is preferred to circulate the air in oven so as to ensure rapid and even drying. The humidity of the air in the oven need not be controlled. However, drying tends to be more rapid at lower humidity levels.

The membrane meshes produced by the methods described above may be from about 50 to 500 μm thick, or more. Preferably, the thickness of the membrane mesh is about 75 to 200 μm. More preferably, the membrane mesh thickness is about 90 to 150 μm. Any useful thickness of membrane can be prepared by varying the process parameters following the teachings herein.

Membrane Architecture

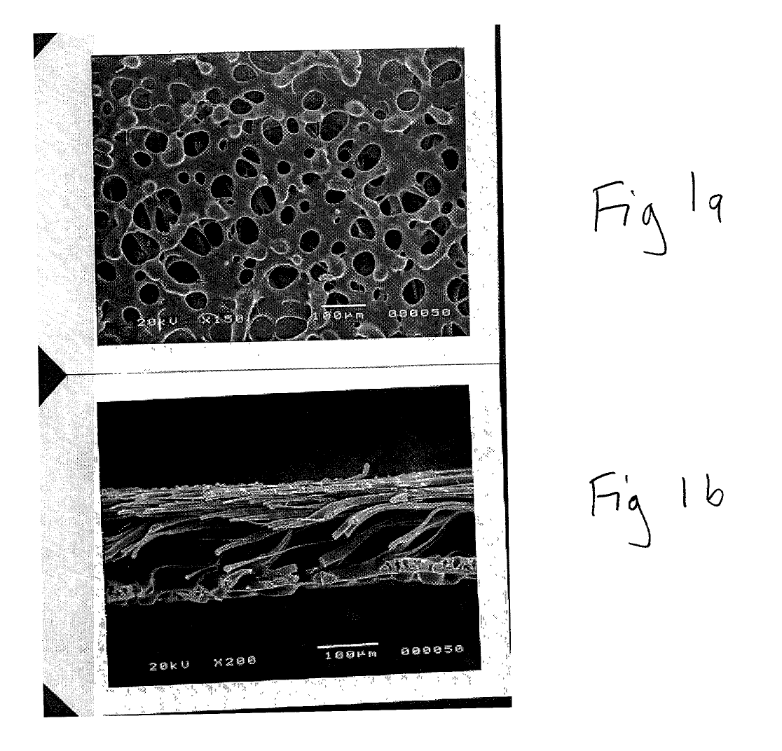

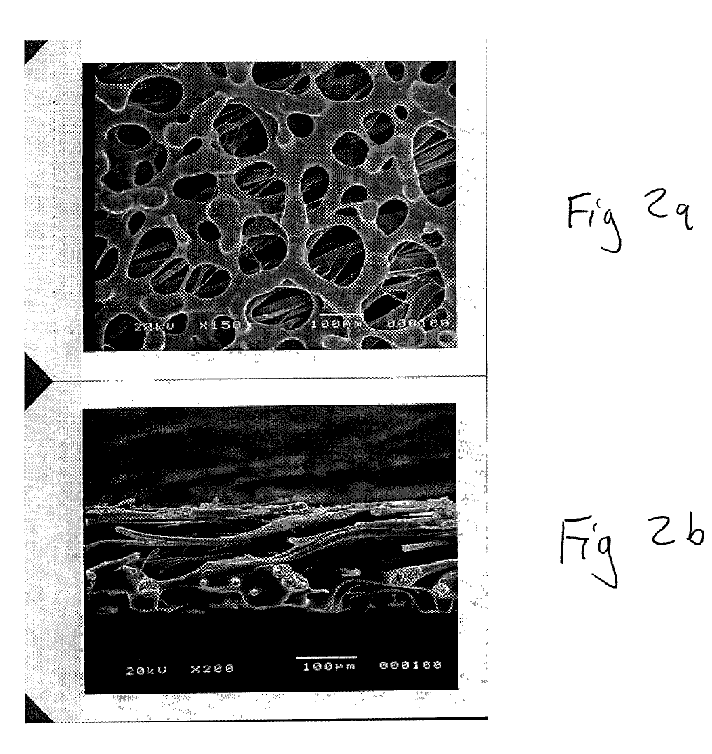

Preferred membrane meshes of the preferred embodiments are made from polysulfones and have large pore diameters. Pore sizes up to about 500 microns may be obtained. Pore sizes preferably range from about 10 μm to about 200 μm, more preferably from about 20 μm to about 150 μm, and most preferably from about 30 μm to about 100 μm. A convenient method for assessing the pore diameter of membrane meshes is through the use of scanning electron microscopy (SEM). FIGS. 1 and 2 are SEM micrographs of membrane meshes made by the methods described herein. FIG. 1a shows a surface of a membrane mesh having an average pore size of about 50 μm. FIG.1b is a cross-section of the same membrane mesh. FIG. 2a shows a surface of a membrane mesh having an average pore size of about 100 μm. FIG. 2b shows a cross-section of the same membrane mesh.

Pore diameter in membranes is typically estimated by porometry analysis and by separate measurement of the bubble point, with a higher bubble point indicating tighter pores. However, as discussed below, these methods are not effective in measuring pore size in the membrane meshes of the preferred embodiments due to their extremely large pore size.

Porometry consists of applying gradually increasing pressures on a wet membrane and comparing gas flow rates with those of the dry membrane, which yields data on pore diameters as well as the bubble point. Porometry measurements give the “mean flow pore diameter” of the membrane. The mean flow pore diameter is the average size of the limiting pores in a membrane. The mean flow pore diameter is based on the pressure at which air flow begins through a pre-wetted membrane (the bubble point pressure) compared to the pressure at which the air flow rate through a pre-wetted membrane is half the air flow rate through the same membrane when dry (the mean flow pore pressure).

The bubble point pressure is the minimum pressure required to push a bubble of air through a wetted membrane. The bubble point indicates the size of the largest limiting pores. As illustrated below in the bubble point data for the membrane meshes of the Examples, the bubble point is <6.9 kPa (<1 psi), which is the threshold pressure for the bubble point test.

Composites Including Membrane Meshes

In preferred embodiments, the polymer membrane meshes are fabricated into composite membranes or filters. Such composites have multiple layers and are useful in a variety of separations applications. In many cases, the various layers of a composite membrane or filter each impart different desirable properties. For example, in some applications, an extremely thin membrane may have advantageous flow rates in separations of very small particles, gasses, and the like. Yet such a thin membrane may be fragile and difficult to handle or to package into cartridges. In such cases, the fragile, thin layer membrane may be combined with a membrane mesh of a preferred embodiment as a backing to form a composite having improved strength and handling characteristics without sacrificing the separations properties of the thin layer membrane. Other desirable properties imparted by laminating a membrane to a membrane mesh may include increased burst strength, increased thickness, and providing pre-filtration capability.

Composite membranes or filters incorporating the membrane meshes of the preferred embodiments may be prepared using lamination techniques. In a typical lamination process, for example, the membrane mesh and one or more additional sheets are layered together to form a stack, which is then laminated into an integral composite under application of heat and pressure. An adhesive substance may be placed in between the membrane mesh and the adjacent sheet prior to lamination to facilitate binding and lamination of the mesh and sheet to each other. Another approach to preparing composite membranes is to cast or form one membrane layer in situ on top of another layer such as, for example, a membrane mesh. Alternatively, the membrane mesh may be cast or form atop another layer, such as, for example, a membrane or other backing material.

### EXAMPLE 1

Membrane meshes were prepared from a casting dope comprising 65.2 wt. % N-methylpyrrolidone (99.8% pure by weight, from International Specialty Products, Wayne, N.J.), 19.5 wt. % polyethylene glycol (Carbowax PEG 200 from Union Carbide, Danbury Conn.), 4.3 wt. % polyvinylpyrrolidone (Luviskol K-90 from BASF, Mount Olive, N.J.); 2.0% water; and 9.0 wt. % polysulfone (polyarylsulfone P-3500). The casting conditions included an air gap of 0.79 m (31″), a speed of 1.2 meters per minute (4 feet per minute) (resulting in an gaseous atmosphere exposure time of 38 seconds), a quench temperature of 43° C. (110° F.), a dope temperature of 24° C. (76° F.), a knife temperature of 24° C. (75° F.), an air gap temperature of 32° C. (90° F.), and an air gap relative humidity of 55%. After quenching in water, the membrane mesh was rinsed in a water bath. The rinsed membrane mesh was then dried at an oven temperature of (325° F.). The resulting membrane mesh was internally hydrophilic and exhibited instantaneous wetting with water. The flow rate of water through the membrane was greater than 30,000 ml/min at 6.9 kPa (10 psi) for a 90 mm diameter disc, the maximum flow rate of the filtration fixture. The pore size was determined by SEM evaluation to be about 50 μm. The bubble point was measured at less than 0.69 kPa (1 psi), the lower limit on pressure. The resulting membrane mesh was 140 μm thick. The mesh displayed a breaking strength of 219 gram force (gf) and elongation of 6% as determined using an Instron Model #5542 (available from Instron of Canton, Mass.). FIG.1a illustrates a porous surface of the membrane, and FIG.1b shows a cross section of the membrane.

### EXAMPLE 2

A membrane mesh was prepared from a casting dope as described in Example 1. The casting conditions were identical, except that a speed of 3 feet per minute was used (resulting in a gaseous atmosphere exposure time of 52 seconds). The resulting membrane mesh was determined by SEM evaluation to have a pore size of about 100 μm. The membrane mesh thickness was 140 μm. Wettability, water flow rate, and bubble point were similar to those observed for the membrane mesh of Example 1. The break strength of the membrane mesh was 135 gf, and the elongation was 4% as determined using an Instron Model #5542. FIG. 2a illustrates the porous surface of the membrane, and FIG. 2b shows a cross section of the membrane.

### EXAMPLE 3

Effect of Exposure Time

To determine the effect of exposure time on pore size, the data of Examples 1 and 2 was compared. The casting dope and casting conditions were identical, except that in Example 1 the exposure time was 38 seconds while in Example 2, the exposure time was 52 seconds. The 38 second exposure time resulted in a membrane having an average pore size of about 50 μm, while a longer exposure time of 52 seconds produced a pore size of about 100 μm. Thus, increasing the exposure time has the effect of increasing pore size. For shorter exposure time periods, pore size tends to increase substantially linearly with increased exposure time. A maximum pore size of approximately 500 μm is obtained for an exposure time of approximately 2 to 3 minutes.

### EXAMPLE 4

Effect of Humidity

A determination of the effect of humidity on pore size is conducted by preparing two membrane meshes from identical casting dopes and casting conditions, except that the first membrane is prepared by exposing the cast film to a humid atmosphere having a relative humidity of 20%, and the second membrane prepared by exposing the cast film to a humid atmosphere having a relative humidity of 70%. The first membrane prepared under the higher humidity conditions shows a larger pore size than the membrane prepared under the lower humidity conditions. This is because there is more water present in the higher humidity atmosphere to be absorbed by the cast film to form the pores. The more water that is absorbed, the larger the pores. In the lower humidity atmosphere, less water is present in the atmosphere to be absorbed by the cast film, so a longer exposure time is necessary for the film to absorb the same quantity of water as does the cast film exposed to higher humidity conditions. Thus, increasing humidity has the effect of increasing pore size. Pore size tends to increase substantially linearly as humidity is increased. At high humidity levels, namely those near 100% humidity, condensation may be difficult to control which may result in water droplets falling on the nascent membrane, resulting in deleterious effects.

### EXAMPLE 5

Effect of Polymer Concentration

The effect of polymer concentration in the casting dope on pore size is determined by preparing two membrane meshes under identical casting conditions, except that the first membrane is prepared from a casting dope comprising 20 wt. % polymer, and the second membrane is prepared from a casting dope comprising 2 wt. % polymer, with the remaining 18 wt. % being made up of solvent. The membrane comprising 20 wt. % polymer has a smaller pore size than the membrane comprising 2 wt. % polymer. In general, higher polymer content in the dope results in a smaller pore size and a stronger membrane, all else being equal.

### EXAMPLE 6

Effect of Polymer Chemistry

The effect of polymer chemistry on pore size is determined by preparing two membrane meshes under identical casting conditions, except that the first membrane is prepared from a casting dope comprising polysulfone as the polymer, and the second membrane is prepared from a casting dope comprising PVDF as the polymer. Because polysulfone and PVDF have different phase inversion rates, the resulting membrane meshes have different pore sizes. Generally, different polymers tend to have different phase inversion rates. Therefore, membrane meshes prepared from different polymers tend to have different pore sizes, all else being equal.

### EXAMPLE 7

Effect of Solvent Concentration

The effect of solvent concentration in the casting dope on pore size is determined by preparing two membrane meshes under identical casting conditions, except that the first membrane is prepared from a casting dope comprising 80 wt. % solvent, and the second membrane is prepared from a casting dope comprising 60 wt. % solvent, with the remaining 20 wt. % being made up of non-solvent. The membrane prepared from the dope having a higher solvent concentration has a smaller pore size. Generally the higher the concentration of solvent in the casting dope, the smaller the pore size of the resulting membrane, all else being equal.

### EXAMPLE 8

Effect of Solvent Chemistry

The effect of solvent chemistry on pore size is determined by preparing two membrane meshes under identical casting conditions, except that the first membrane is prepared from a casting dope comprising N-methylpyrrolidone as the solvent, and the second membrane is prepared from a casting dope comprising dimethylformamide as the solvent. The membrane prepared from a casting dope comprising N-methylpyrrolidone has a smaller pore size than the membrane prepared from dimethylformamide. In general, different solvents yield different pore sizes, all else being equal.

### EXAMPLE 9

Effect of Non-Solvent Concentration

The effect of non-solvent concentration in the casting dope on pore size is determined by preparing two membrane meshes under identical casting conditions, except that the first membrane is prepared from a casting dope comprising 80 wt. % solvent, and the second membrane is prepared from a casting dope comprising 60 wt. % solvent, with the remaining 20 wt. % being made up of non-solvent. The membrane prepared from the dope having a higher non-solvent concentration has larger pores. Generally, the higher the non-solvent concentration in the casting dope, the larger the pore size, all else being equal.

### EXAMPLE 10

Effect of Non-Solvent Chemistry

The effect of non-solvent chemistry on pore size is determined by preparing two membrane meshes under identical casting conditions, except that the first membrane is prepared from a casting dope comprising water as the non-solvent, and the second membrane is prepared from a casting dope comprising octanol as the non-solvent. The membrane prepared from the casting dope containing octanol has a smaller pore size than the membrane prepared from the casting dope containing water. Generally, different non-solvents yield membrane meshes with different pore sizes, all else being equal.

### EXAMPLE 11

Effect of Temperature of the Cast Dope, Quench Bath, and Air Gap

To determine the effect of the temperature of the cast dope, quench bath, and air gap on pore size, four membrane meshes are prepared. The first membrane is prepared as in Example 1. A second membrane is prepared from an identical casting dope under identical casting conditions as in the first membrane, except that the dope temperature is 25° C. (77° F.) instead of 76° C. (167° F.). The second membrane has a larger pore size than the first membrane. Generally, the higher the dope temperature, the smaller the pore size of the resulting membrane, all else being equal. A third membrane is prepared from an identical casting dope under identical casting conditions as the first membrane, except that the quench bath temperature is 25° C. (77° F.) instead of 110° C. (230° F.). The third membrane has smaller pores than the first membrane. Generally, the higher the quench bath temperature, the larger the pore size of the resulting membrane, all else being equal. A fourth membrane is prepared from an identical casting dope under identical casting conditions as the first membrane, except that the air gap temperature is 25° C. (77° F.) instead of 90° C. (194° F.). The fourth membrane has a smaller pore size than the first membrane. Generally, the higher the air gap temperature, the larger the pore size of the resulting membrane, all else being equal. Quench bath temperature generally tends to have a greater effect on pore size than either casting dope temperature or air gap temperature. Casting dope temperature generally tends to have a smaller effect on pore size than either quench bath temperature or air gap temperature.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A polymer membrane mesh, the membrane mesh comprising a first surface having first surface pores, a second surface having second surface pores, and a support structure between the first surface and the second surface, the support structure having a reticular network of flow channels connecting the pores of the first surface with the pores of the second surface, wherein both or either of the first surface pores and the second surface pores have an average pore diameter of greater than or equal to about 10 μm.

2. The membrane of claim 1, wherein the average pore diameter of at least the first surface pores or the second surface pores ranges from greater than about 20 μm.

3. The membrane of claim 1, wherein the average pore diameter of at least the first surface pores or the second surface pores ranges from about 10 μm to about 200 μm.

4. The membrane of claim 3, wherein the average pore diameter of at least the first surface pores or the second surface pores ranges from about 20 μm to about 150 μm.

5. The membrane of claim 4, wherein the average pore diameter of at least the first surface pores or the second surface pores ranges from about 30 μm to about 100 μm.

6. The membrane of claim 1, wherein the membrane possesses a bubble point of less than about 1 psi.

7. The membrane of claim 1, wherein the membrane possesses a water flow rate of greater than about 30,000 ml/min for a 90 mm diameter disc of the membrane at a pressure of 10 psi.

8. The membrane of claim 1, wherein the membrane has a thickness greater than about 50 μm.

9. The membrane of claim 1, wherein the membrane has a thickness ranging from about 50 μm to about 500 μm.

10. The membrane of claim 9, wherein the membrane has a thickness ranging from about 75 μm to about 200 μm.

11. The membrane of claim 10, wherein the membrane has a thickness ranging from about 90 μm to about 150 μm.

12. The membrane of claim 1, wherein the polymer comprises a sulfone polymer.

13. The membrane of claim 12, wherein the sulfone polymer is selected from the group consisting of polyethersulfone, polyarylsulfone, polysulfone, and mixtures thereof.

14. The membrane of claim 1, wherein the polymer is selected from the group consisting of polyvinylidene fluoride, acrylic copolymer, polyolefin, polyester, polytetrafluoroethylene, polyurethane, polycarbonate, poly(tetrafluoroethylene-co-ethylene), polyamide, polystyrene, and mixtures thereof.

15. The membrane of claim 11, wherein the polyolefin is selected from the group consisting of polyethylene and polypropylene.

16. The membrane of claim 1, further comprising a hydrophilic component.

17. The membrane of claim 13, wherein the hydrophilic component is selected from the group consisting of polyvinylpyrrolidone, polyethylene glycol, polyvinylacetate and mixtures thereof.

18. The membrane of claim 13, having a weight ratio of polymer to hydrophilic component from about 1:20 to about 20:1.

19. The membrane of claim 15, wherein the weight ratio ranges from about 1:10 to about 10:1.

20. A method for preparing a polymer membrane mesh, the method comprising:
providing a casting dope comprising a polymer, a nonsolvent, and a solvent;
casting the dope to form a thin film;
exposing the film to a humid atmosphere for a period of time sufficient to allow formation of surface pores greater than about 10 μm in diameter;
coagulating the film in a coagulation bath; and
recovering from the coagulation bath a polymer membrane mesh, the membrane mesh comprising a first surface having first surface pores, a second surface having second surface pores, and a support structure between the first surface and the second surface, the support structure having a reticular network of flow channels connecting the pores of the first surface with the pores of the second surface, wherein both or either of the first surface pores and the second surface pores have an average pore diameter greater than about 10 μm.

21. The method of claim 17, further comprising:
rinsing the mesh in a rinsing bath, wherein said rinsing step is conducted after said coagulating step.

22. The method of claim 17, further comprising:
drying the mesh at an elevated temperature.

23. The method of claim 17, wherein the period of time ranges from about 20 seconds to about 2 minutes.

24. The method of claim 20, wherein the period of time ranges from about 20 seconds to about 70 seconds.

25. The method of claim 21, wherein the period of time ranges from about 30 seconds to about 60 seconds.

26. The method of claim 20, wherein the period of time ranges from about 35 seconds to about 55 seconds.

27. The method of claim 17, wherein the humid atmosphere has a humidity ranging from about 30% relative humidity to about 100% relative humidity.

28. The method of claim 17, wherein the humid atmosphere has a humidity ranging from about 40% relative humidity to about 100% relative humidity.

29. The method of claim 17, wherein the humid atmosphere has a humidity ranging from about 40% relative humidity to about 70% relative humidity.

30. The method of claim 22, wherein the humid atmosphere has a humidity ranging from about 50% relative humidity to about 69% relative humidity.

31. The method of claim 23, wherein the humid atmosphere has a humidity of about 55% relative humidity.

32. The method of claim 17, wherein the dope comprises a homogeneous solution.

33. The method of claim 17, wherein the dope comprises a dispersion.

34. The method of claim 17, wherein the nonsolvent is selected from the group consisting of alcohols, alkanes, ketones, carboxylic acids, ethers, esters, and mixtures thereof.

35. The method of claim 17, wherein the nonsolvent is selected from the group consisting of 2-methoxyethanol, propionic acid, t-amyl alcohol, methanol, ethanol, isopropanol, hexanol, heptanol, octanol, acetone, butyl ether, methylethylketone, methylisobutylketone, ethyl acetate, amyl acetate, glycerol, diethyleneglycol, di(ethyleneglycol)diethylether, di(ethyleneglycol)dibutylether, polyethylene glycol, propionic acid, hexane, propane, nitropropane, heptane, octane, and mixtures thereof.

36. The method of claim 17, wherein the nonsolvent comprises water.

37. The method of claim 29, wherein the nonsolvent comprises a mixture of polyethylene glycol and water.

38. The method of claim 17, wherein the dope comprises from about 12 wt. % to about 32 wt. % of nonsolvent.

39. The method of claim 31, wherein the dope comprises from about 15 wt. % to about 29 wt. % of nonsolvent.

40. The method of claim 32, wherein the dope comprises from about 18 wt. % to about 26 wt. % of nonsolvent.

41. The method of claim 33, wherein the dope comprises from about 20 wt. % to about 24 wt. % of the nonsolvent.

42. The method of claim 17, wherein the solvent is selected from the group consisting of dimethylformamide, dimethylacetamide, dioxane, dimethylsulfoxide, chloroform, tetramethylurea, tetrachloroethane, and mixtures thereof.

43. The method of claim 17, wherein the solvent comprises N-methylpyrrolidone.

44. The method of claim 17, wherein the dope comprises from about 50 wt. % to about 80 wt. % of solvent.

45. The method of claim 37, wherein the dope comprises from about 55 wt. % to about 75 wt. % of solvent.

46. The method of claim 38, wherein the dope comprises from about 60 wt. % to about 70 wt. % of solvent.

47. The method of claim 39, wherein the dope comprises from about 64 wt. % to about 66 wt. % of solvent.

48. The method of claim 17, wherein the dope comprises from about 2 wt. % to about 20 wt. % of polymer.

49. The method of claim 41, wherein the dope comprises from about 4 wt. % to about 15 wt. % of polymer.

50. The method of claim 42, wherein the dope comprises from about 5 wt. % to about 10 wt. % of polymer.

51. The method of claim 17, wherein the polymer comprises polysulfone.

52. The method of claim 44, wherein the dope comprises about 9 wt. % of polysulfone.

53. The method of claim 17, wherein the dope further comprises a hydrophilic component.

54. The method of claim 46, wherein the dope comprises from about 1 wt. % to about 10 wt. % of hydrophilic component.

55. The method of claim 47, wherein the dope comprises from about 2 wt. % to about 6 wt. % of hydrophilic component.

56. The method of claim 48, wherein the dope comprises from about 3 wt. % to about 5 wt. % of hydrophilic component.

57. The method of claim 49, wherein the dope comprises from about 4 wt. % to about 5 wt. % of hydrophilic component.

58. The method of claim 46, wherein a weight ratio of polymer to hydrophilic component ranges from about 1:5 to about 20:1.

59. The method of claim 46, wherein the weight ratio ranges from about 1:2 to about 1:4.

60. The method of claim 51, wherein the polymer comprises polysulfone.

61. The method of claim 17, wherein the coagulation bath comprises water.

62. The method of claim 17, wherein the coagulation bath is at a temperature ranging from about 2° C. to about 85° C.

63. The method of claim 54, wherein the coagulation bath is at a temperature ranging from about 24° C. to about 63° C.

64. The method of claim 55, wherein the coagulation bath is at a temperature ranging from about 32° C. to about 54° C.

65. The method of claim 56, wherein the coagulation bath is at a temperature ranging from about 38° C. to about 48° C.

66. The method of claim 17, wherein the rinse bath comprises water.

67. The method of claim 17, wherein the membrane mesh possesses a bubble point of less than about 1 psi.

68. The method of claim 17, wherein the membrane mesh possesses a water flow rate of greater than about 30,000 ml/min for a 90 mm diameter disc of the membrane at a pressure of 10 psi.
